(19) United States
(12) Patent Application Publication
(10) Pub. No.: US 2026/0334443 A1
(43) Pub. Date: Oct. 29, 2026

(54) ANCHORING DEVICE FOR A FISHING ROD

(71) Applicant: TAKING TIME FLY FISHING LTD, Devon (GB)

(72) Inventors: Charles Edward Brian THOMSON, London (GB); Claire Eileen THOMSON, London (GB)

(21) Appl. No.: 19/486,290

(22) PCT Filed: May 22, 2024
(86) PCT No.: PCT/GB2024/051322

§ 371 Date: Nov. 20, 2025

(30) Foreign Application Priority Data
May 23, 2023 (GB) 2307673.0
May 22, 2024 (GB) 2407258.9

(51) Int. Cl. A01K 91/02

(52) U.S. Cl. CPC A01K 91/02

(57) ABSTRACT

An anchoring device for a fishing rod (4), which includes an elongate anchor member (6) and a means (2) to attach the anchor member (6) to the rod (4) during use. The anchor member (6) also includes a first section (14) which is orientated parallel to the rod (4) when the device is attached; a second section (18) which is orientated parallel to the rod (4) when the device is attached; and wherein the first and second sections (14, 18) are divided by a middle section (16) which extends generally perpendicular to the rod (4) when the device is attached.

### RELATED APPLICATIONS

This application is a national phase entry of International Patent Application No. PCT/GB2024/051322, filed May 22, 2024, which claims priority from Great Britain Patent Application No. 2307673.0, filed May 23, 2023 and Great Britain Patent Application No. 2407258.9, filed May 22, 2024, the entire disclosures of which are incorporated herein by reference.

### FIELD OF THE INVENTION

The present invention relates to an anchoring device for a fly-fishing rod. More especially, the invention relates to an anchoring device that facilitates a novel technique of casting in fly fishing.

### BACKGROUND TO THE INVENTION

Fly fishing is a method of fishing that typically involves using a specialised fishing rod, reel and tapered line to cast an artificial fly or lure onto the surface or into a body of water in order to attract and catch fish. Fly fishing is often considered a more challenging and complex form of fishing beyond that of traditional bait or lure fishing, as it requires a far greater degree of coordination, skill and technique to properly deliver a cast and ‘present’ the fly and set the hook when a fish strikes.

There are a variety of casting techniques used in fly fishing, one of which is known as the ‘bow and arrow’ cast. To perform this type of cast, the fisherman holds the line just above the fly with one hand, in the other, the rod is aimed at the desired target. The fly line is then pulled taut, and the rod is bent backwards towards the fisherman. Once the tension of the line has loaded the rod with potential energy the ‘recovery’ of the rod tip delivers the line out across the water. This casting method takes its name from the equipment used in archery due to the similarity of the action. There are two benefits to using ‘bow and arrow’ cast. Firstly, it is useful to use in situations when there is limited space behind the fisherman to make a back cast that is required to load the rod. This makes the ‘bow and arrow’ cast particularly useful in locations such as small streams or places with overhanging trees. Secondly, it can be a highly accurate method of casting, as it allows the fisherman to precisely aim where they want the fly to be placed.

The main issue with the ‘bow and arrow’ cast is that has significantly limited range. The target distance is usually limited by physically how far back the line can be pulled while keeping it taut, which is roughly a maximum of 2×the length of the fishing rod. When being pulled back, potential energy is stored in the rod. This is known as ‘loading’ the rod. When the line is released, the potential energy loaded within the rod is transferred to the fly line which propels it forward towards the target, which is known as ‘the delivery’ of the cast. This means that only a relatively short length of the line can be held taut, ultimately limiting the range of a fly to a target. To increase the distance that a fly can travel using this method, a fisherman could hold excess line by looping additional line tightly in their hand. The additional total length of line allows the fly to be delivered to a greater range. However, this method requires a great deal of dexterity and adds to complication of the procedure and increases the likelihood of potential failure of the delivery of the cast, as well as problems with line management.

To achieve greater range whilst maintaining accuracy requires significant practice to master.

The present invention seeks to facilitate a novel method of fly cast that significantly improves upon the existing range and accuracy of the ‘bow and arrow’ cast and any variations of it by utilising an anchor system, whereby the fly is anchored directly or indirectly to the fishing rod.

Hook-securing devices for fishing for rods are known. The product branded Lureboi Hook Keeper for example discloses a fishing rod with a securing device for the hook to prevent it from moving during transport or storage. The hook-securing device's construction though would not allow for the simple and effective release of the hook during a casting action.

### STATEMENT OF INVENTION

According to one aspect to the invention, there is provided an anchoring device for a fishing rod comprising an elongate anchor member and means to attach the anchor member to the rod during use, wherein the anchor member includes a first section which is orientated parallel to the rod when the device is attached; a second section which is orientated parallel to the rod when the device is attached; wherein the first and second sections are divided by a middle section which extends generally perpendicular to the rod when the device is attached.

Preferably, the anchor member is rotatable.

Preferably, the anchor member is made from a singular construction.

Preferably, the anchor member is made from metal.

Preferably, the means of attaching said anchor member further comprises a base structure.

Preferably, the means of attaching said anchor member is an aperture located on the base, through which the rod is locatable.

Alternatively, the means of attaching said anchor member is an O-ring locatable within a groove located on the external periphery of the base.

Alternatively, the means of attaching said anchor member is a snap-fit mechanism wherein the fishing rod is located within a recess on the base.

Preferably, the base is made from rubber.

Alternatively, the base is made from plastic.

Alternatively, the base is made from a biodegradable material.

Preferably, the surface of the base comprises visual indentations.

According to a second aspect there is provided a method of anchoring a fly having a hook portion against a fishing rod prior to casting, utilising the anchoring device of the first aspect, wherein the method comprises the steps of attaching the anchoring device to the rod; and locating the hook member of the fly over the middle section of the anchor member.

### BRIEF DESCRIPTION OF DRAWINGS

One embodiment will now be described with reference to the accompanying figures, in which: FIG. 1 is perspective view of anchoring device constructed in accordance with one embodiment of the invention, anchoring a fishing rod fly in use;

FIG. 2 is a further perspective view of the anchoring device of FIG. 1;

FIGS. 3A and 3B are a perspective views of an anchoring device in accordance with a second embodiment of the invention, showing a groove running along the external periphery to facilitate an alternate attachment means;

FIGS. 4A and 4B are a perspective views of an anchoring device in accordance with a third embodiment of the invention, showing a vertical split around the rod receiving aperture as a further alternative attachment means;

FIGS. 5A and 5B are perspective views of an anchoring device in accordance with a fourth embodiment of the invention, showing a sloped top and bottom surface.

### DESCRIPTION OF THE INVENTION

An anchoring device used for providing a means of casting fly line in fly fishing is shown in the figures.

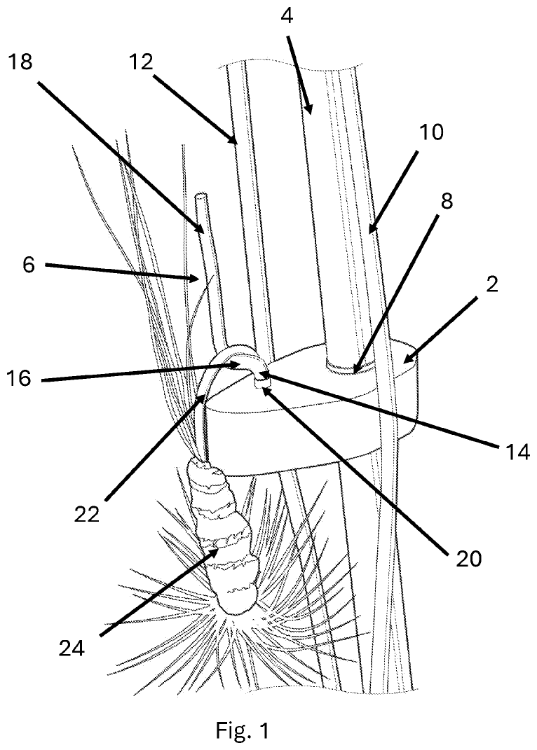

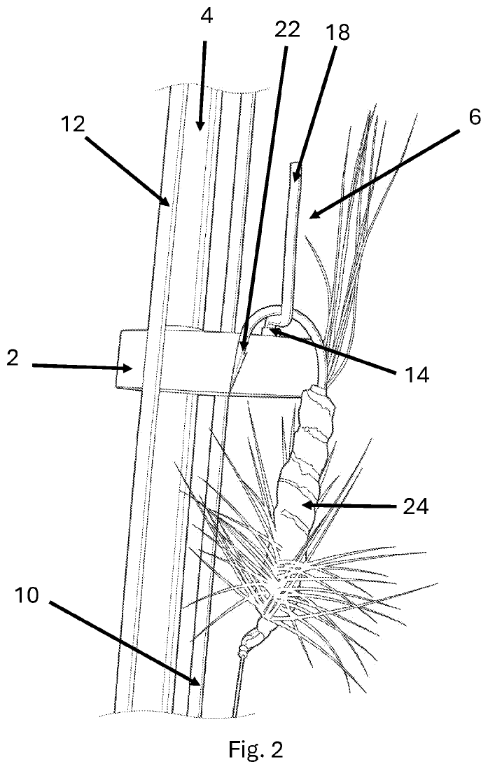

Referring to FIGS. 1 and 2, the anchoring device comprises a base 2 which, in use, is anchored to and around a fly-fishing rod 4 in use, and an anchor member 6 outwardly extending (upwardly) from the base 2.

The base 2 is made of a suitably rigid material such as rubber or plastic. Preferably, the material has a high coefficient of friction to enhance its grip to and against the rod 4, or additionally the base may be made from a biodegradable material. The anchor member 6 is preferably made from a singular metal wire material which is deformed to form a plurality of sections (herein interchangeably referred to as ‘arms’).

One end of the base 2 includes an aperture 8 through which the fishing rod can be received in use to attach the device to the fishing rod 4, between the head 10 and the front taper 12. A fly-fishing rod is usually made from multiple sections and the base 2 is slid onto the desired section of rod, ideally located around ⅔ to ¾ from the butt of rod 4, thus providing the optimal weight of the head section of the fishing line outside of the rod tip to achieve successful delivery of the fly.

The base 2 is retained at the desired position along the rod 4 through friction. The device may include a simple clamping mechanism if required as an attachment means. Suitable attachment means may include, without limitation, an O-ring/rubber gasket or a vertical split which facilitates a snap-fit attachment to base 2.

The anchor member 6 comprises a first arm 14, orientated generally parallel to the rod in use, leading to a horizontal section 16 orientated generally perpendicular to first arm 14 and in turn leading to a second arm 18 offset from the first arm 14 and extending in generally the same parallel plane of the first arm 14.

The distal end of the first arm 14 of the anchor member 6 is received within a second aperture 20 in the base 2 of the device such that the arm 14 is rotatable about base 2 to allow different orientations of the anchor member 6, to accommodate left-or right-handed users.

In all orientations, the first arm and second arms 14, 18 are orientated generally parallel to the rod 4 in use. In the embodiment shown, the horizontal section 16 is generally orientated perpendicular to the rod 4.

In use, the horizontal arm 16 is of a length sufficient to extend beyond the side of the base 2 (the vertical extension of the second arm 18 being offset from the base 2) to a minimal extent but to allow the hook 22 of the fly 24 to be located over the horizontal section 16 to hold the fly 24 in a location adjacent to on the side of the base 2, parallel to the rod 4, while being un-impeded by base 2 during the fly's release when it is cast.

At the same time, length of the horizontal arm 16 is sufficiently short to prevent rotation of the fly 24, which could lead to failure of the casting method.

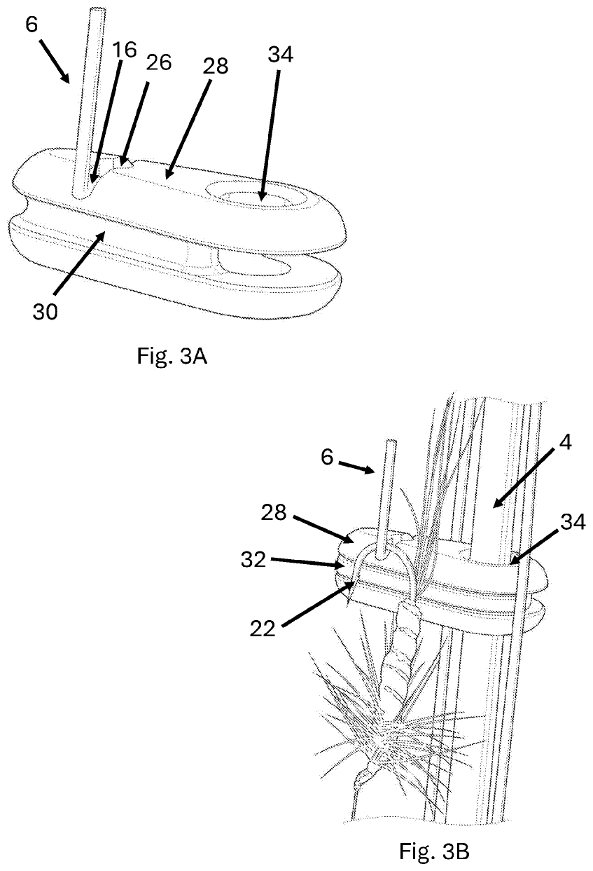

The top and/or bottom surface of the base 2 may include visual indentations or grooves 26 (as shown in FIGS. 3 to 5) to indicate varying preferred orientations of the anchor member 6 to provide different casting affects.

In a further embodiment of the invention (not shown), the anchor device is constructed from a single article of metal wire. A first portion of this wire is coated in rubber and entwined around the circumference of the rod, while a second portion of exposed wire forms the anchor member. The anchor member may be L-shaped or inverted T-shaped, having a horizontal member and a vertical member. The horizontal member is generally aligned perpendicular to the backing and to the rod and the vertical member is generally aligned parallel to the rod. The vertical member may be orientated towards the rod grip.

In another embodiment of the invention, the anchor is attached, for example soldered, to an eye of the fishing rod.

In another embodiment of the invention, shown in FIGS. 3A and 3B, the base 28 shows an alternative means of attaching the anchoring device to the rod 4. Extending along the external periphery of base 28 along its horizontal axis is a groove 30, in use a rubber O-ring 32 is located and tensioned in the groove 30 as shown in FIG. 3B.

The depth of the groove 30 is generally consistent around the device, however in the area proximal to aperture 34, the depth extends directly into the aperture 34, ensuring contact between the O-ring 32 and the rod 4.

Once located at the desired position on the rod 4, the tension in the O-ring 32 imparts a compressive force, securing it to the rod 4.

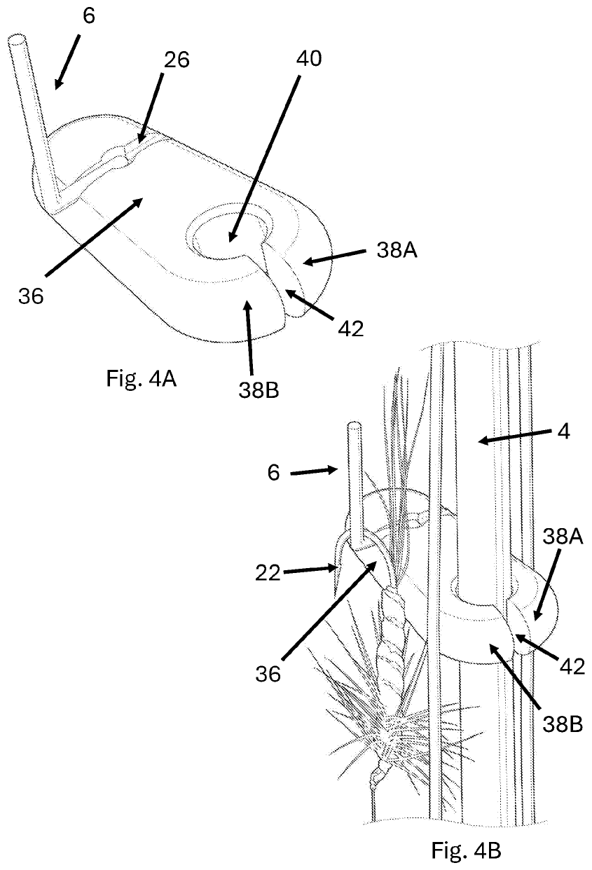

The embodiment shown in FIGS. 4A and 4B shows another suitable means of attaching the anchoring device to rod 4, in the form of a snap-fit mechanism. Base 36 includes arms 38A and 38B, which forms a circular recess 40 which extends vertically between the top and bottom surfaces of the base 36. Located between the ends of arms 38 is a split 42. In the embodiment shown, the ends of the arms 38 are parallel to each other, however in alternate embodiments (not shown), the ends of the arms 38 may not be parallel to each other.

Once located at the desired position on the rod 4, the rod is aligned with split 42. The rod 4 is then gently pushed into the recess 40, where the arms 38A and 38B securely hold the rod 4 in place within recess 40.

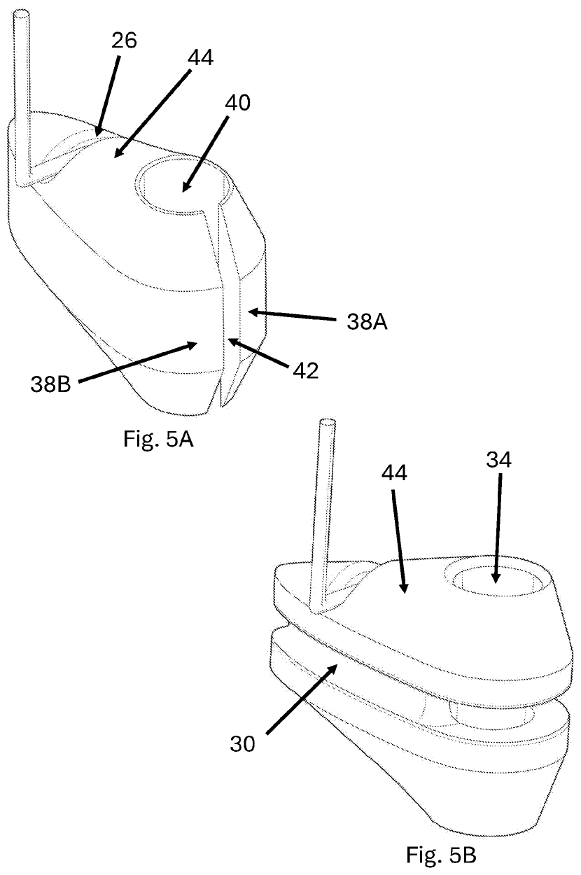

In a further embodiment of the invention shown in FIGS. 5A and 5B, the top and bottom surfaces of the base 44 are sloped, in particular, it is sloped towards the aperture 34 or recess 40.

As the method of fly-fishing will be described below, the anchor member 6 is constructed and designed to provide a locator for the fly. Wherein the hook portion of the fly is retained by the horizontal section 16 and vertical arm 18 of the anchor member 6 of the anchoring device, thereby preventing slippage or dislodgement of the fly during the loading of the rod.

The method steps the fly-fishing using anchoring device of the present invention are set out below.
Unspool the desired amount of fly line,
b) Locate the artificial fly 24 on the anchoring device so that the hook of the fly it is retained against the horizontal section 16 and vertical arm 18 of the anchor member of the device,
c) While maintaining tension on the leader, trap the leader under the thumb of the rod-holding hand,
   d) Unloop the line from around the base of reel.
e) Direct the rod towards the rod towards the target,
f) With the other hand, hold the line between the thumb and index finger, at the appropriate point that allows the appropriate tension on the rod tip and therefore optimal loading of the fly rod.
g) Pull the line back, ensuring the rod tip is bent towards the fisherman and the fly line is taut,
h) Aim at the target using the hand that holds the rod. The line follows the rod tip.
i) Release the line from the hand to subsequently allow the rod tip recovery therefore delivering the line and fly towards the target.

1. An anchoring device for a fishing rod comprising an elongate anchor member and means to attach the anchor member to the rod during use, wherein the anchor member includes:
a first section which is orientated parallel to the rod when the device is attached;
a second section which is orientated parallel to the rod when the device is attached;
wherein the first and second sections are divided by a middle section which extends
generally perpendicular to the rod when the device is attached.

2. The anchoring device according to claim 1, wherein the anchor member is rotatable.

3. The anchoring device according to claim 1, wherein the anchor member is made from a singular construction.

4. The anchoring device according to claim 1, wherein the anchor member is made from metal.

5. The anchoring device according to claim 1, wherein the means of attaching said anchor member further comprises a base structure.

6. The anchoring device according to claim 5, wherein the means of attaching said anchor member is an aperture located on the base structure, through which the rod is locatable therein.

7. The anchoring device according to claim 5, wherein the means of attaching said anchor member is an O-ring locatable within a groove located on the external periphery of the base structure.

8. The anchoring device according to claim 5, wherein the means of attaching said anchor member is a snap-fit mechanism wherein the fishing rod is located within a recess on the base structure.

9. The anchoring device according to claim 5, wherein the base is made from rubber.

10. The anchoring device according to claim 5, wherein the base is made from plastic.

11. The anchoring device according to claim 5, wherein the base is made from a biodegradable material.

12. The anchoring device according to claim 5, wherein the surface of the base structure comprises visual indentations.

13. A method of anchoring a fly having a hook portion against a fishing rod prior to casting, wherein the method comprises the steps of:
providing an anchoring device comprising an elongate anchor member and means to attach the anchor member to the rod during use, wherein the anchor member includes (a) a first section which is orientated parallel to the rod when the device is attached; and (b) a second section which is orientated parallel to the rod when the device is attached; wherein the first and second sections are divided by a middle section which extends generally perpendicular to the rod when the device is attached;
attaching the anchoring device to the rod; and
locating the hook member of the fly over the middle section of the anchor member.
